(19) United States
(12) Patent Application Publication
(10) Pub. No.: US 2019/0313572 A1
(43) Pub. Date: Oct. 17, 2019

(54) METHOD FOR SELECTING SEEDS INTENDED FOR SOWING

(71) Applicant: RIJK ZWAAN ZAADTEELT EN ZAADHANDEL B.V., De Lier (NL)

(72) Inventor: Peter Wilhelmus Dorothea Reinders, De Lier (NL)

(21) Appl. No.: 16/424,925

(22) Filed: May 29, 2019

Related U.S. Application Data
(63) Continuation-in-part of application No. PCT/EP2017/082912, filed on Dec. 14, 2017.

(30) Foreign Application Priority Data
Dec. 14, 2016 (NL) 2017999

(51) Int. Cl. A01C 1/02

(52) U.S. Cl. CPC A01C 1/025; A01C 1/04

(57) ABSTRACT

The present invention relates to a method for selecting a seed intended for sowing. The method comprises subjecting a seed to germination conditions and selecting a seed that has germinated as a seed intended for sowing. As a result, only seeds which are likely to develop into a commercially interesting plant need to be sown and grown into plants.

### RELATED APPLICATIONS AND INCORPORATION BY REFERENCE

This application is a continuation-in-part application of international patent application Serial No. PCT/EP2017/082912 filed 14 Dec. 2017, which published as PCT Publication No. WO 2018/109115 on 21 Jun. 2018, which claims benefit of NL patent application Serial No. 2017999 filed 14 Dec. 2016.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to a method that improves the efficiency of producing plants, and in particular to a method for selecting seeds intended for sowing.

### BACKGROUND OF THE INVENTION

When seeds are sown not all of the seeds will eventually germinate, resulting in a significant loss of plants. This is a major problem for many crops and also for certain applications of crops, such as for instance for Salatrio. Salatrio is a concept wherein seeds of three different lettuce varieties are sown in a single pot. It frequently occurs that one or more of these seeds do not germinate and the entire pot is discarded. Even if the pot also contained one or two germinated seeds, the pot is discarded because it cannot be sold as Salatrio. This can lead to a loss of up to 12% of Salatrio pots.

In order to compensate for the loss of plants, plant growers usually sow more seeds. This takes up a lot of space in the greenhouse or the field and requires a lot of extra labour, not only in sowing the extra seeds but also in sorting the seeds that are germinated from the seeds that have not properly germinated. The ones that have not properly germinated need to be discarded, thereby producing a lot of unnecessary waste in the form of for instance potting soil and substrate.

Citation or identification of any document in this application is not an admission that such document is available as prior art to the present invention.

### SUMMARY OF THE INVENTION

It is therefore an object of the present invention to provide a more efficient and less expensive method for producing plants. This is achieved by providing a method wherein seeds that are likely to grow into commercially interesting plants are selected in a very early stage, and the seeds that will likely not grow into commercially interesting plants are discarded at that stage. The seeds are distinguished from one another based on their germination capacity. Plant growers thus no longer need to sow seeds that will likely not result in commercially interesting plants.

It would further be beneficial if all plants have the same size, or comprise the desired number and/or size of fruits, at a particular point in time. It is for instance possible that a seed will germinate but that it takes too long for the seed to grow into a plant of the desired size. This means that this plant cannot be harvested at the same time as the other plants, and either needs to be harvested at a later stage or is discarded as waste.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U. S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIGS. 1A-1C show a schematical overview of the method of the invention. In FIG. 1A a controlled climate chamber is depicted, with a seed tape winded on a cassette. Seeds are fixated on the seed tape. In FIG. 1B, the seed tape is unwinded from the cassette and the seeds are analysed one-by-one through a camera. FIG. 1C shows a view from above from a part of the unwinded seed tape. From this view it can be determined whether the radicle of a seed has just become visible or not. With a check mark it is indicated that the seed is suitable for seeding and growing into a plant; with a cross it is indicated that the seed is not suitable for seeding and growing into plant.

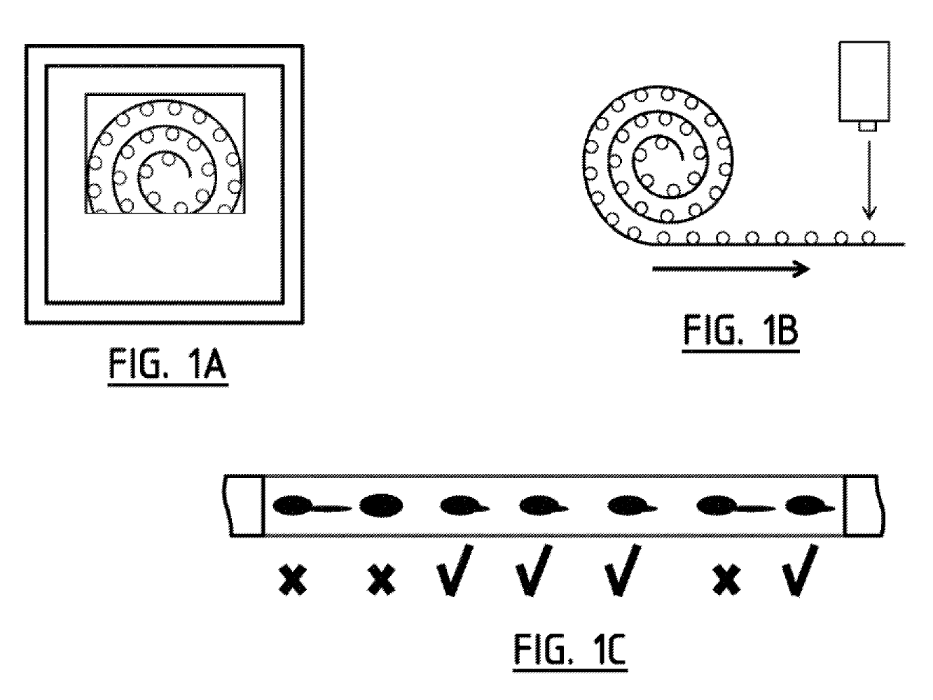

### DETAILED DESCRIPTION OF THE INVENTION

The present invention thus relates to a method for selecting a seed intended for sowing, which may comprise:
subjecting a seed to germination conditions to germinate the seed until the radicle becomes visible; and
selecting a germinated seed as a seed intended for sowing based on the visibility and/or the length of the radicle,
wherein a seed that is not germinated is not intended for sowing.

The invention also relates to a system for selecting a seed intended for sowing, which may comprise:
means for germinating seeds; and
means for selecting germinated seeds intended for sowing.

In the context of the present invention, the “seed intended for sowing” is a seed that is likely to result in a commercially interesting plant when exposed to normal growing conditions. A seed that will likely not result in a commercially interesting plant when exposed to normal growing conditions is not selected. A plant grower can thus purposively select seeds that are to be sown, without having to sow seeds that will likely not result in the desired plants.

Whether a seed is likely to result in a commercial interesting plant can be determined on the basis of the germination of the seed. Therefore, a seed is subjected to germination conditions in order to germinate the seed. The seed is germinated until the stage wherein the radicle becomes visible. This is markedly different from the priming of seeds, as for priming it is considered undesirable if the radicle is already visible outside the seedcoat. Primed seed batches with seeds that have their vulnerable radicles outside the seed are normally discarded, as they are very prune to damage during further seed distribution. Generally, this is an important cause of seedling death. In the method of the present invention, however, such seeds are produced and selected on purpose. They are very gently and very precise handled and planted. Prior to subjecting a seed to germination conditions, a seed may be preselected based on X-ray analysis.

The seed may for instance be part of a seed batch. The seed that is subjected to the germination conditions may be a primed seed or X-ray selected seeds Processes for priming seeds are known in the art and depend on the climate zone in which the plants are grown. Seeds are normally primed with water and optionally with light in order to break dormancy.

The seed may be germinated in or on any suitable medium. Preferably, the medium allows for the visual inspection of an emerging radicle from the seed. In one embodiment, the seed is germinated in a liquid, in a cassette, in a mesh, on a tablet, on a sheet, on a mat or on tape. Water, nutrients and oxygen required for seed germination are suitably applied to the liquid, cassette, mesh, tablet, sheet, mat or tape. If tape is used, the seed is applied onto the tape which may subsequently be rolled-up. The seed is subjected to the germination conditions in this rolled-up state. Once the seed is, or in case of a seed batch at least part of the seeds are, germinated, the tape can be rolled off and the selection of the seeds that is, or the seeds that are, germinated can take place when the seed is, or the seeds are, still present on the tape. Depending on the type of selection means, it may be required that the emerging radicle is visible. In this case, the seed(s) may be germinated on transparent tape.

In one embodiment, the seed is subjected to the germination conditions in a controlled climate chamber. A controlled climate chamber is a closed space wherein climate conditions, such as temperature, lighting, gas composition, moisture, etc. can be controlled. As such, optimal conditions for germinating seeds can be created. Preferably, the controlled climate chamber is a compact chamber having a size comparable to the size of a fridge. The advantage of such a compact size is that the chamber can be easily placed at the plant grower's premises such that the entire process from selecting seeds intended for sowing to the sowing of the selected seeds and growing plants thereof can be performed at these premises.

The seed may be primed in the controlled climate chamber, in which case the seed does not have to be dried back before initiating germination.

Preferably, the seed is subjected to ideal germination conditions, which are the conditions that are optimal for germinating the seed. The conditions optimal for germination of the seed can be readily determined by a plant grower and depend on the crop, variety, application, etc. Ideal or optimal germination conditions ensure optimal germination and therefore uniform growth of the plants resulting from germinated seeds. Uniform growth contributes to an improved number of plants that have the same size, and/or comprise the desired number and/or size of fruits, at a particular point in time. Pilling, coating and/or disinfection of the seeds are no longer required. If a controlled climate chamber is used at the conditions optimal for germinating the seeds, the germination of a seed batch may be improved to achieve a germination of 100%, i.e. all seeds in the seed batch germinate. Besides from being more efficient, this also adresses food safety and environmental issues. The controlled climate chamber may be pre-programmed at the conditions optimal for the germination of the seeds of a particular crop.

Once the seed, or in case of a seed batch, at least part of the seeds, is germinated, the seed is subjected to a selection step. A seed is considered germinated when the radicle has started to emerge from the seed. The selection step involves observing a seed, detecting if the seed is germinated or not germinated, and selecting the seed if the seed is germinated. The seed that is not germinated may be discarded. A seed that is discarded because it has not germinated may again be subjected to germination conditions and the subsequent selection step. The selection step may thus comprise observing a single seed, detecting if the single seed is germinated and selecting the single seed if it is germinated. It is however also envisaged that the selection step may comprise observing multiple seeds, detecting germinated seeds and seeds that are not germinated, and selecting the germinated seeds.

The germinated seeds are selected based on the visibility and/or length of the radicle. In the context of the present invention, the length of a radicle is not bound by a minimum. On the contrary, there is a maximum length of a radicle. If the radicle of a germinated seed is too long, it is too fragile when such a germinated seed is (automatically) transferred for sowing. Also, the further development of a germinated seed into a seedling might be hampered if the radicle is too long: the radicle might not be optimally positioned in the sowing medium after transfer. The maximum length of a radicle depends on the plant species to which the germinated seed belongs. A germinating seed can also be selected as soon as germination can be observed. This can for example also be observed through changes in the seed coat composition and/or its structure. Germinated seeds that fulfil the predetermined criteria are seeds intended for sowing, as these are likely to result in commercially interesting plants.

In one embodiment, the maximum length of the radicle of a germinated seed is, in increasing order of preference, 30 mm, 25 mm, 20 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm.

In another embodiment, seed that are selected by means of the method and system of the invention, include but are not limited to seeds from plant species belonging to the following genera: Spinacia, Lactuca, Solanum, Daucus, Cucumis, Cucurbita, Eruca, Brassica, Raphanus, Apium, Cichorium, Phaseolus, Beta, Valerianella, Diplotaxis, Allium, Asparagus, Foeniculum, Citrullus and Fragraria. Germinated seed from any of these plant species may have any of the aforementioned maximum radicle lengths for it to be classified as seed intended for growing.

The present invention provides a method and a system for the selection of seeds. A seed can be defined as a plant embryo that is enclosed in a protective outer covering, the seed coat. During germination, the embryo imbibes water and starts growing again after a shorter or longer period of dormancy. During these early steps of germination, the embryonic tissues are loosened and the seed coat usually splits allowing more moisture to reach and penetrate the embryo. Once rehydration has been completed, the further metabolic processes of germination can start.

The selection of a germinated seed is suitably performed by using imaging means. The imaging means are arranged such that one or more images of the seed are formed on which a radicle emerging from the seed can be detected. The information from the one or more images is processed within the imaging means and/or by other means connected to the imaging means. The processing of the image information involves a comparison with predetermined criteria, such as the visibility and/or the length of the radicle. If the image information fulfils the predetermined criteria, the seed from which the image was taken is selected. For example, an image is taken from a seed having a radicle of a particular size. This size of the radicle is compared to a predetermined size. If the size of the radicle fulfils the predetermined size, the seed from which the image was taken is selected as a seed intended for sowing. A seed having a radicle size longer than the predetermined size will not be selected. The predetermined size of a radicle may vary between crops and between varieties of one crop. Suitable imaging means can be selected by a person skilled in the art and may depend on the type of seed. Imaging means having a wavelength range of 10⁻¹² to 10⁻³ meter are generally considered suitable. Preferably, the imaging means comprise one or more cameras or X-ray devices. The camera might enable hyperspectral, multispectral, infra red (IR), thermal or RGB imaging. Most preferably, the imaging means comprise one or more 2D-cameras and/or 3D cameras or a combination thereof

Selection of the germinated seed may be performed by selecting the seed that fulfils the predetermined criteria and/or by discarding the seed that does not fulfil the predetermined criteria. Seeds may be selected by using means for handling seeds, such as means that pick up the seeds, means that push or blow the seeds in a certain direction, and/or means that suck up the seeds. If the seeds are present on tape, the seed may be selected by punching the seed out of the tape.

The selection step may involve the formation of a single image or multiple images. For instance, a first image can be made to detect if a seed is germinated or not and a second image may be made to determine if the seed handling means have picked up a seed or the correct seed. In this case, the second image serves as a control step.

A selected seed can be stored or directly sown. The method may therefore further comprise sowing the selected seeds. The selected seed can for instance be directly sown in a tray, on agar, in a pressed pot or rockwool. Advantageously, the selected seed is sown directly after selection in/on the medium in/on which it is present. Preferably, sowing is performed by using a sowing machine or a robot. Sowing machines are known in the prior art.

As a result of the present invention, only seeds that will likely become a commercially interesting plant need to be sown. This greatly reduces the space, labour and waste involved with growing plants, as well as with the transportation of plants. In addition, the use of a controlled climate chamber in which optimal germination conditions can be created to germinate the seed provides several further advantages. For instance, the quality of a batch of plants that form the end product is improved as higher uniformity is reached, and the time to grow the seeds to an end product can be decreased. Especially because it is no longer necessary to provide the seed in a seed pill or coating.

In a particular embodiment, a seed is subjected to germination conditions in a controlled climate chamber and a germinated seed is selected by using a camera and means for handling seeds, such as means for punching seeds out of tape, means for picking seeds, means for pushing seeds, means for blowing seeds and means for sucking seeds.

In another particular embodiment, a seed or seeds on transparent tape is/are subjected to germination conditions in a controlled climate chamber to obtain transparent tape which may comprise a germinated seed or a seed that is not germinated, or germinated seeds and seeds that are not germinated, exposing the transparent tape which may comprise the germinated seed or the seed that is not germinated, or germinated seeds and seeds that are not germinated, to one or more cameras to observe the germinated seed(s) and/or seed(s) that is/are not germinated, and selecting the germinated seed(s) by punching the germinated seed(s) out of the transparent tape. Preferably, the transparent tape which may comprise seed(s) is rolled-up when the seed is, or seeds are, subjected to the germination conditions and rolled-off when the germinated seed(s) and/or seed(s) that are not germinated are exposed to the one or more cameras.

Preferably the means for germinating seeds comprises a controlled climate chamber as described above. The controlled climate chamber is arranged to receive seeds in a liquid, cassette, in a mesh, on a tablet, on a sheet, on a mat or on tape, in particular transparent tape. As an example, tubes comprising the seeds in a liquid may be placed in a holder arranged to receive said tubes. The tube holders may be placed on one or more shelves in the controlled climate chamber. Cassettes or tapes comprising a seed or seeds may also be placed on one or more shelves. Roles of tape may alternatively be placed in fastenings means attached to the controlled climate chamber.

The controlled climate chamber is further arranged to provide conditions which are optimal for the germination of the seeds. The conditions optimal for the germination of seeds vary depending on the crop and/or variety, and can be readily determined by a person skilled in the art. Preferably, the controlled climate chamber is pre-programmed at the conditions optimal for germinating seeds of a particular crop, or variety. In this respect the settings for the conditions optimal for the germination of the seeds in the controlled climate chamber may be operated manually on the controlled climate chamber or automated by a computer connected to the controlled climate chamber. The computer may be a local or a remote computer.

Preferably, the means for selecting comprises imaging means as described above. The system may further comprise sowing means.

The system is at least partly automated. Preferably, the selection means are automated.

The invention further relates to the use of imaging means for the selection of seeds intended for sowing. Preferably, the imaging means comprises one or more cameras, in particular one or more 2D and/or 3D-cameras, and/or one or more X-ray devices, as described above. The cameras might enable hyperspectral, multispectral, infra red (IR), thermal or RGB imaging.

The invention furthermore relates to a method for increasing the percentage of plants obtained from a seed batch, which may comprise:
subjecting seeds of a seed batch to germination conditions to germinate the seeds until the radicle becomes visible;
selecting the seeds that are germinated based on the visibility and/or the length of the radicle;
only sowing the selected seeds; and
growing plants from the sown seeds.

In this method, seeds are subjected to germination conditions and selected in accordance with the description above. The selected seeds are sown and plants are grown therefrom according to standard methods in the art.

Although the present invention and its advantages have been described in detail, it should be understood that various changes, substitutions and alterations can be made herein without departing from the spirit and scope of the invention as defined in the appended claims.

The present invention will be further illustrated in the following Example which is given for illustration purposes only and are not intended to limit the invention in any way.

### Example

Cucumber seeds (variety Proloog) were fixated on a seed tape, which was winded on a cassette. The cassette comprising the seed tape was subsequently incubated in a controlled climate chamber. Settings were adjusted to optimal conditions for this cucumber variety. After 2 days the cassette was removed from the controlled climate chamber and seeds were analysed one-by-one. In total 100 seeds were analysed. Of this number 72 seeds were deemed suitable for planting. A total of 15 seeds were found to have a radicle that is too long for further processing. The remaining 13 seeds did not (yet) show any of germination and were not selected for planting at this stage, i.e. the radicle was not visible at the time of the analysis. The seeds that were deemed suitable for planting were removed from the tape and placed in a pot with a suitable compost. The seeds that were found to have a too long radicle were discarded. The seeds that did not germinate were also discarded.

### The Invention is Further Described by the Following Numbered Paragraphs:

1. Method for selecting a seed intended for sowing, comprising:
a) subjecting a seed to germination conditions to germinate the seed until the radicle becomes visible; and
b) selecting a germinated seed as a seed intended for sowing based on the visibility and/or the length of the radicle,
   wherein a seed that is not germinated is not intended for sowing.

2. Method for increasing the percentage of plants obtained from a seed batch, comprising:
a) subjecting seeds of a seed batch to germination conditions to germinate the seeds until the radicle becomes visible;
b) selecting the seeds that are germinated sowing based on the visibility and/or the length of the radicle;
c) only sowing the selected seeds; and
d) growing plants from the sown seeds.

3. Method of paragraph 1 or 2, wherein the seed that is, or the seeds that are, subjected to germination conditions is a primed seed or are primed seeds.

4. Method of paragraph 1 or 3, further comprising sowing the selected seed.

5. Method of any one of paragraphs 1-4, wherein the seed is, or the seeds are, germinated in a liquid, in a cassette, in a mesh, on a tablet, on a sheet, on a mat or on tape.

6. Method of paragraph 5, wherein the tape is transparent tape.

7. Method of any one of paragraphs 1-6, wherein the step of subjecting a seed or seeds to germination conditions is performed in a controlled climate chamber.

8. Method of any one of paragraphs 1-7, wherein the selection of a germinated seed or germinated seeds comprises observing a seed or the seeds, detecting if the seed is or seeds are germinated or not germinated, and if the seed is or seeds are germinated selecting the germinated seed or seeds.

9. Method of paragraph 8, further comprises discarding a seed that is, or the seeds that are, not germinated.

10. Method of any one of paragraphs 1-9, wherein a germinated seed is, or germinated seeds are, a seed or seeds of which the radicle is just visible.

11. Method of any one of paragraphs 1-10, wherein the selection of the germinated seed or seeds is performed by using imaging means.

12. Method of paragraph 11, wherein the imaging means comprise a camera or an X-ray device.

13. Method of paragraph 12, wherein the camera is a 2D or 3D-camera.

14. Method of any one of paragraphs 1-13, wherein a seed is, or seeds are, subjected to germination conditions in a controlled climate chamber and a germinated seed is, or germinated seeds are, selected by using a camera and means for handling seeds.

15. Method of paragraph 14, wherein the handling means is selected from the group consisting of means for punching seeds out of tape, means for picking seeds, means for pushing seeds, means for blowing seeds and means for sucking seeds.

16. System for selecting a seed intended for sowing, comprising:
a) means for germinating a seed; and
b) means for selecting a germinated seed intended for sowing.

17. System of paragraph 16, wherein the means for germinating seeds comprises a controlled climate chamber.

18. System of paragraph 16 or 17, wherein the controlled climate chamber is arranged for receiving seeds in a liquid, in a cassette, in a mesh, on a tablet, on a sheet, on a mat or on tape.

19. System of any one of paragraphs 16-18, wherein the means for selecting comprise imaging means.

20. System of paragraph 19, wherein the imaging means comprise a camera and/or an X-ray device.

21. System of paragraph 20, wherein the camera is a 2D or 3D-camera.

22. System of any one of paragraphs 16-21, wherein the means for selecting further comprise means for punching seeds out of tape, means for picking seeds, means for pushing seeds, means for blowing seeds and/or means for sucking seeds.

23. System of any one of paragraphs 16-22, further comprising sowing means.

24. System of any one of paragraphs 16-23, wherein the system is at least partly automated.

25. System of paragraph 24, wherein the means for selecting are automated.

26. Use of imaging means for the selection of seeds intended for sowing.

27. Use of paragraph 26, wherein the imaging means comprise a camera and/or an X-ray device.

28. Use of paragraph 27, wherein the camera is a 2D or 3D-camera.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

1. A method for selecting a seed intended for sowing, comprising:
a) subjecting a seed to germination conditions to germinate the seed until the radicle becomes visible; and
b) selecting a germinated seed as a seed intended for sowing based on the visibility and/or the length of the radicle,
wherein a seed that is not germinated is not intended for sowing or
a method for increasing the percentage of plants obtained from a seed batch, comprising:
a) subjecting seeds of a seed batch to germination conditions to germinate the seeds until the radicle becomes visible;
b) selecting the seeds that are germinated sowing based on the visibility and/or the length of the radicle;
c) only sowing the selected seeds; and
d) growing plants from the sown seeds.

2. (canceled)

3. The method as claimed in claim 1, wherein the seed that is, or the seeds that are, subjected to germination conditions is a primed seed or are primed seeds.

4. The method as claimed in claim 1, further comprising sowing the selected seed.

5. The method as claimed in claim 1, wherein the seed is, or the seeds are, germinated in a liquid, in a cassette, in a mesh, on a tablet, on a sheet, on a mat or on tape.

6. The method as claimed in claim 5, wherein the tape is transparent tape.

7. The method as claimed in claim 1, wherein the step of subjecting a seed or seeds to germination conditions is performed in a controlled climate chamber.

8. The method as claimed in claim 1, wherein the selection of a germinated seed or germinated seeds comprises observing a seed or the seeds, detecting if the seed is or seeds are germinated or not germinated, and if the seed is or seeds are germinated selecting the germinated seed or seeds.

9. The method as claimed in claim 8, further comprises discarding a seed that is, or the seeds that are, not germinated.

10. The method as claimed in claim 1, wherein a germinated seed is, or germinated seeds are, a seed or seeds of which the radicle is just visible.

11. The method as claimed in claim 1, wherein the selection of the germinated seed or seeds is performed by using imaging means.

12. The method as claimed in claim 11, wherein the imaging means comprise a camera or an X-ray device.

13. The method as claimed in claim 12, wherein the camera is a 2D or 3D-camera.

14. The method as claimed in claim 1, wherein a seed is, or seeds are, subjected to germination conditions in a controlled climate chamber and a germinated seed is, or germinated seeds are, selected by using a camera and means for handling seeds.

15. The method as claimed in claim 14, wherein the handling means is selected from the group consisting of means for punching seeds out of tape, means for picking seeds, means for pushing seeds, means for blowing seeds and means for sucking seeds.

16. A system for selecting a seed intended for sowing, comprising:
a) means for germinating a seed; and
b) means for selecting a germinated seed intended for sowing.

17. The system as claimed in claim 16,
wherein the means for germinating seeds comprises a controlled climate chamber or
wherein the controlled climate chamber is arranged for receiving seeds in a liquid, in a cassette, in a mesh, on a tablet, on a sheet, on a mat or on tape or
wherein the means for selecting comprise imaging means, such as a camera (such as a 2D or 3D-camera) and/or an X-ray device or
wherein the means for selecting further comprise means for punching seeds out of tape, means for picking seeds, means for pushing seeds, means for blowing seeds and/or means for sucking seeds or
further comprising sowing means or
wherein the system is at least partly automated or
wherein the means for selecting are automated.

18-25. (canceled)

26. A method for selecting seeds intended for sowing comprising detecting one or more images of a radicle emerging from the seed on an imaging means.

27. The method of claim 26, wherein the imaging means comprise a camera and/or an X-ray device.

28. The method of claim 27, wherein the camera is a 2D or 3D-camera.
